(19) United States
(12) Patent Application Publication
(10) Pub. No.: US 2022/0092622 A1
(43) Pub. Date: Mar. 24, 2022

(54) ATTRIBUTE GENERATION DEVICE, ATTRIBUTE GENERATION METHOD AND ATTRIBUTE GENERATION PROGRAM

(71) Applicant: NEC Corporation, Minato-ku, Tokyo (JP)

(72) Inventors: Tomoya SAKAI, Tokyo (JP); Yasuhiro SOGAWA, Tokyo (JP)

(73) Assignee: NEC Corporation, Minato-ku, Tokyo (JP)

(21) Appl. No.: 17/420,026

(22) PCT Filed: Jan. 10, 2019
(86) PCT No.: PCT/JP2019/000567

§ 371 Date: Jun. 30, 2021

(51) Int. Cl. G06Q 30/02; G06N 5/04

(52) U.S. Cl. CPC G06Q 30/0205; G06N 5/045; G06Q 30/0206

(57) ABSTRACT

The learning unit 81 learns an attribute viewpoint model in which attributes of a target are explanatory variables for each target person so as to minimize a difference between a prediction result by a predictor that predicts an evaluation result of each target person based on a feature vector of the target person and a prediction result by a prediction model that predicts an evaluation result learned for each target person, using the attributes of the target as explanatory variables. The attribute generation unit 82 generates an attribute so that an evaluation result obtained according to the attribute applied to the learned prediction model satisfies the specified objective.

### TECHNICAL FIELD

The present invention relates to an attribute generation device, an attribute generation method and an attribute generation program for generating attributes of a target of interest.

### BACKGROUND ART

In order to create new value in the business scene, new products and services continue to be devised and offered every day through creative activities. Since there are various factors for making a product or service profitability, there are many things to consider when enumerating the combination of factors that are likely to lead to profitability from the development viewpoint. Therefore, it is time-consuming to perform these tasks manually by humans, and there is a possibility of oversight.

Furthermore, from a marketing viewpoint, if a new product or service that is intuitively conceived by a human being does not reach the users who will pay for it, the value of the product or service will not be utilized. In addition, it is costly and time-consuming to conduct research on the effectiveness of a developed product or service on a specific user group. In addition, even if there is a possibility that an unexpected user group will pay for the product or service during the research stage, there is a possibility that the user group that will pay for the product or service will be left out during the research planning stage based on human intuition alone.

Thus, it is difficult for a human being to grasp all the past information and create a new plan that has a high chance of success. On the other hand, a computer is capable of considering a lot of information and then presenting the most likely combinations. Therefore, various methods of considering new products and services have been proposed to deal with this problem.

Patent literature 1 describes a system that provides counseling on cosmetics suitable for customers based on accumulated product data. The system described in patent literature 1 proposes products based on usage evaluation data generated based on responses to a questionnaire from customers, and if there is no product that can be proposed, the system determines that the product is the one the customer wants to realize.

In addition, non-patent literature 1 describes a method for designing a new movie using features of the target user population. In the method described in the non-patent literature, a new movie is designed by learning preference of users for movie attributes and selecting the movie attributes that maximize preference of target users under the condition of budget constraint.

### CITATION LIST

### Patent Literature

Patent literature 1: Japanese Patent Laid-Open No. 2003-85303

### Non-Patent Literature

Non-Patent literature 1: Koutra, D., Dighe, A., Bhagat, S., Weinsberg, U., Ioannidis, S., Faloutsos, C., & Bolot, J., “PNP: Fast path ensemble method for movie design”, In Proceedings of the 23rd ACM SIGKDD International Conference on Knowledge Discovery and Data Mining, pp. 1527-1536, August 2017.

### SUMMARY OF INVENTION

### Technical Problem

In the system described in patent literature 1, the characteristics of a product that need to be newly developed are identified by repeatedly proposing the products to customers. This requires cooperation of the users, and also involves a lot of cost, since multiple products need to be used by the customers.

In addition, the method described in the non-patent literature 1 learns the average preference (rating) of the target users for the attributes, and designs the movie so that the sum of the ratings of the selected attributes is large. However, the method described in the non-patent literature 1 does not take into account the high rating of the movie itself (i.e., movie sales, etc.).

In other words, the method described in the non-patent literature 1 only evaluates the individual attributes of the target users, not the entire attributes, so the simple sum of the evaluations of the individual attributes is not necessarily the evaluation of the entire attributes. Furthermore, since the method described in the non-patent literature 1 does not perform prediction based on the individual features of the target users themselves, it is not possible to generate attributes based on the features of the target users.

For this reason, it is desirable to be able to generate attributes that represent targets for different objectives, such as an image of a new product that can be expected to generate high profits, or an image of users who can be expected to generate high profits for a certain product, based on past data.

Therefore, it is an object of the present invention to provide an attribute generation device, an attribute generation method and an attribute generation program that can generate attributes representing a target according to the objective.

### Solution to Problem

An attribute generation device according to the present invention includes a learning unit which learns an attribute viewpoint model in which attributes of a target are explanatory variables for each target person so as to minimize a difference between a prediction result by a predictor that predicts an evaluation result of each target person for each target based on a feature vector of the target person and a prediction result by a prediction model that predicts an evaluation result learned for each target person, using the attributes of the target as explanatory variables, and an attribute generation unit which generates an attribute so that an evaluation result obtained according to the attribute applied to the learned prediction model satisfies a specified objective.

An attribute generation method according to the present invention includes learning an attribute viewpoint model in which attributes of a target are explanatory variables for each target person so as to minimize a difference between a prediction result by a predictor that predicts an evaluation result of each target person for each target based on a feature vector of the target person and a prediction result by a prediction model that predicts an evaluation result learned for each target person, using the attributes of the target as explanatory variables, and generating an attribute so that an evaluation result obtained according to the attribute applied to the learned prediction model satisfies a specified objective.

An attribute generation program according to the present invention, causes a computer to execute a learning process of learning an attribute viewpoint model in which attributes of a target are explanatory variables for each target person so as to minimize a difference between a prediction result by a predictor that predicts an evaluation result of each target person for each target based on a feature vector of the target person and a prediction result by a prediction model that predicts an evaluation result learned for each target person, using the attributes of the target as explanatory variables, and an attribute generating process of generating an attribute so that an evaluation result obtained according to the attribute applied to the learned prediction model satisfies a specified objective.

### Advantageous Effects of Invention

According to the present invention, it is possible to generate attributes that represent the target according to the objective.

### BRIEF DESCRIPTION OF DRAWINGS

FIG. 1 It depicts a block diagram showing a configuration example of an example embodiment of an attribute generation device according to the present invention.

FIG. 2 It depicts a flowchart showing an example of a setting process when generating attributes.

FIG. 3 It depicts a flowchart showing an operation example of an attribute generation device.

FIG. 4 It depicts an explanatory diagram showing a specific example of a process of generating attributes.

FIG. 5 It depicts an explanatory diagram explaining an operation example of generating attributes.

FIG. 6 It depicts an explanatory diagram explaining an operation example of generating a target person image and selecting a target person.

FIG. 7 It depicts a block diagram showing a summarized attribute generation device according to the present invention.

FIG. 8 It depicts a summarized block diagram showing a configuration of a computer for at least one example embodiment.

### DESCRIPTION OF EMBODIMENTS

First, before explaining the attribute generation device, zero-shot learning will be explained. It is a technique related to the present invention. Zero-shot learning is a learning method for predicting a label in a class or task at test time, even if training data to which a corresponding label is added does not exist for the class or task at learning time. In zero-shot learning, a predictor with two inputs is constructed. The inputs are feature of the target person and an attribute of the target.

By using this method, for example, in the case of classification, even if an unknown class exists at test time, classification becomes possible if there is an attribute that explains the class, in the case of regression, even if an unknown task exists at test time, prediction becomes possible if there is an attribute that explains the task. For example, in the situation of predicting the sales of a new product, the unknown task corresponds to the new product, and the target of prediction corresponds to the sales.

Since the sales of a new product for example can be predicted by zero-shot learning, it can be said that zero-shot learning is a method that can estimate in advance whether sales are high or low, even for a new product. From this, the inventors came up with the idea that it is possible to generate attributes of a new product from its high sales. In other words, the inventors came up with the idea that it is possible to generate attributes that represent a target from objectives such as sales and satisfaction.

Specifically, in the present invention, when the components of a new product, a new store, and a new service are expressed as a collection of attribute variables, combinations of attribute variables that are likely to lead to products, stores, and services, that are expected to generate high profits, are generated based on data. A user image that would pay a high price for developed a new product or service, or a user image that is closer to the objective among users existing in a given group is selected.

In the present invention, attributes of the target are generated in line with the evaluation results desired by the target user. In the following, in order to facilitate the understanding of the invention, the case of generating attributes of a products with high average sales that are considered to be good on average for the target user is explained as appropriate as a specific example. However, the target user is an example of a target person, and the target person may be not only an individual user but also a group and a company. An average of sales (average sales) is an example of one evaluation results, and evaluation results include the aggregate results (average, top, etc.) of various so-called ratings such as sales and satisfaction. A product is an example of a target, and a target may be not only a product but also a service, a store, etc.

Hereinafter, example embodiments of the present invention will be described with reference to the drawings.

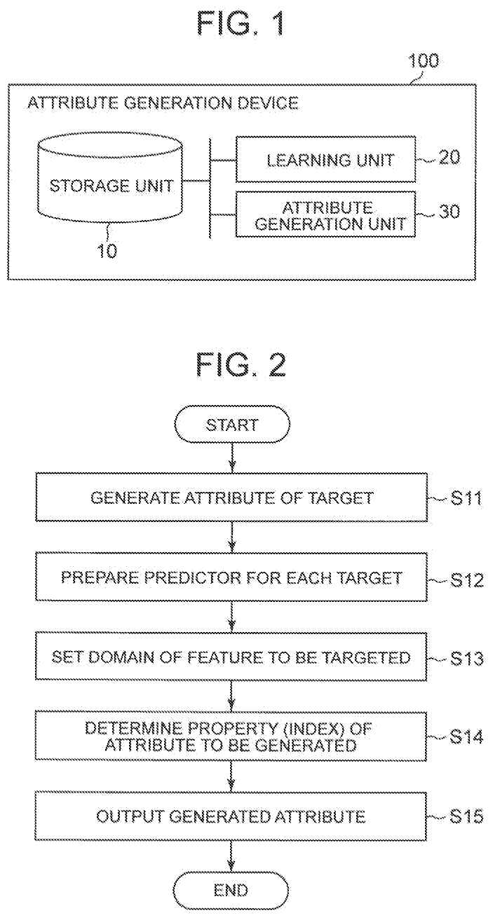

FIG. 1 is a block diagram showing a configuration example of an attribute generation device in the example embodiment according to the present invention. The attribute generation device 100 of this example embodiment has a storage unit 10, a learning unit 20, and an attribute generation unit 30.

The storage unit 10 stores a set of information (hereinafter, referred to as “feature vectors”) that represents features of a target person. For example, the storage unit 10 stores a set of feature vectors of a user. In the following explanation, the feature vector of the user is denoted as xᵢ and the set of feature vectors xᵢ is denoted as {xᵢ∈R^{d}}ⁿᵢ₌₁. Here, n means a number of target persons.

For example, consider an individual user as the target person. In this case, the information that represents the features of the target person includes gender, age, address, and occupation.

The storage unit 10 stores a set of evaluators (predictors) for respective targets. For example, the storage unit 10 stores a set of sales predictors for each product. In the following description, the sales predictor is denoted as hₜ, and the set of predictors lit is denoted as {hₜ: R^{d}→R}^{k}ₜ₌₁. The predictor hₜ outputs an evaluation result using the feature vector as an argument. Specifically, the predictor lit outputs the prediction value of sales y\hat{ }ᵢ (circumflex on yᵢ) using the feature vector as an argument. Here, k means a number of targets (for example, a number of existing products when a product is the target).

For example, consider a predictor that predicts sales. In this case, the predictor uses date information and weather information as input to predict sales. A currently operational predictor may be used for the predictor, or if no corresponding predictor exists, a new one may be created using a common method.

In addition, the storage unit 10 stores a set of attributes that represent the features of each target. In the following explanation, when simply “attribute” is expressed, it is assumed to represent a set of one or more attribute variables (an attribute vector).

Attribute variables are, for example, real values, binary or category values, or a combination of these. Examples of real values include amounts, calories, quantities, and so on. An interval (for example, [0, 1] interval to indicate a percentage, etc.) may be specified to the real value. Binary attribute variables, for example, indicate the presence or absence of information (for example, whether the material is included or not, etc.) and are used when there are two candidates. A category value is used, for example, when there are multiple candidates (for example, by manufacturing company, by type, etc.). The category value can be changed to a binary variable. For example, if category values A, B, and C exist, they can be expressed as [1,0,0], [0,1,0], and [0,0,1], respectively. The above combinations include, for example, an attribute represented by m real values and an attribute represented by t real values and m−t binary values.

The storage unit 10 stores, for example, a set of attribute vectors that represent the features of each product. In the following description, the attribute vector is denoted as aₜ, and the set of attribute vectors at is denoted as {aₜ∈R^{m}|∥aₜ∥²₂=1}^{k}ₜ₌₁.

For example, consider a product (ice cream, etc.) as a target. In this case, the features of the ice cream (i.e., attribute variables) include words extracted from the product name or product description, a type (for example, ice milk), nutritional composition (for example, 7.0% nonfat milk solid, 4.0% milk fat, 0.5% egg fat, etc.), ingredient (for example, dairy products, sugar, honey, egg yolk, etc.), net content, a price, a manufacturer, a use, etc. The attribute variables are not limited to text data, but can also be, for example, an image showing the product package.

In addition, the storage unit 10 stores prediction models of the target attribute viewpoint (hereinafter, referred to simply as the prediction models) for a particular target person x. The prediction model of the target attribute viewpoint is a prediction model in which the attribute variables representing the features of the target are explanatory variables and an evaluation result (for example, sales, satisfaction, etc.) are an objective variable. In other words, this prediction model is a model that shows how an evaluation result will change if the target person is fixed and the target is replaced. In the following explanation, the prediction model for a particular target person x is denoted as fₓ:R^{m}→R. The manner of this prediction model is predetermined.

The storage unit 10 also stores input data that is the target of the prediction. This input data is the data used for predicting using the predictor described above. For example, when predicting sales in August using the above predictor, date information and weather information in August are stored as input data. In addition, the storage unit 10 stores data that maps the input data to a result (prediction result) of applying this input data to the predictor as learning data. The storage unit 10 may store only the learning data based on the prediction result.

The learning data generated in this way can be said to be data that represents the prediction result of a product. Furthermore, since the product can be identified from this learning data, the multiple attributes that represent the features of the product can also be identified.

The learning unit 20 learns a prediction model of the attribute viewpoint of the target based on the learning data. Specifically, the learning unit 20 learns the above prediction model for each target person so as to minimize a difference between the prediction result by the predictor and the prediction result by the prediction model. For example, in the case of focusing on sales of a product to users, the learning unit 20 calculates a first prediction result by applying feature vectors of users to the predictor that predicts sales to users for each product. Furthermore, the learning unit 20 calculates a second prediction result by applying the above learning data to a prediction model that predicts sales learned for each user using the attributes of the products as explanatory variables. Then, the learning unit 20 learns the above prediction model so as to minimize a difference between the first prediction result and the second prediction result.

The method by which the learning unit 20 learns the prediction model is arbitrary. Assuming that the manner of the sales prediction model of the attribute viewpoint is a linear model, the prediction model is represented by Equation 1 illustrated below.

[Math. 1]

fₓ_{ᵢ}(a)=aₜ^{T}sₓ_{ᵢ} (Equation 1)

In this case, the learning unit 20 learns the sales prediction model of the attribute viewpoint by solving the optimization problem of Equation 2 illustrated below for all the target persons. It is noted that λ≥0 in Equation 2 is a regularization parameter. Iₘ∈R^{m×m} illustrated below is an identity matrix.

$$\begin{matrix}[ Math . 2 ] & \\ \begin{matrix}{\hat{s}}_{{x}_{i}} := {arg min}_{{s}_{{x}_{i}}} = {\sum }_{t = 1}^{k} {( {h}_{t} ( {x}_{i} ) - {a}_{t}^{⊤} {s}_{{x}_{i}} )}^{2} + λ {s}_{{x}_{i}}^{⊤} {s}_{{x}_{i}} \\ = {‖ {\hat{y}}_{i} - {As}_{{x}_{i}} ‖}_{2}^{2} + λ {‖ {s}_{{x}_{i}} ‖}_{2}^{2} \\ = {( {A}^{⊤} A + λ {I}_{m} )}^{- 1} {A}^{⊤} {\hat{y}}_{i}\end{matrix} & ( Equation 2 ) \\ where & \\ {\hat{y}}_{i} := {( {h}_{1} ( {x}_{i} ) , … , {h}_{k} ( {x}_{i} ) )}^{⊤} ∈ {ℝ}^{k} & \\ A := {( {a}_{1} , … , {a}_{k} )}^{⊤} ∈ {ℝ}^{k \times m} & \end{matrix}$$

The prediction model is not limited to being a linear model, but may be any other general model, such as a neural network. Generalizing the above Equation 2, the optimization problem solved by the learning unit 20 can be expressed by Equation 3 illustrated below. In Equation 3, W(·) is a regularization function, and λ is a regularization parameter.

$$\begin{matrix}[ Math . 3 ] & \\ {\hat{f}}_{{x}_{i}} := {arg min}_{{f}_{{x}_{i}}} {\sum }_{t = 1}^{k} {( {h}_{t} ( {x}_{i} ) - {f}_{{x}_{i}} ( {a}_{t} ) )}^{2} + λ W ( {f}_{{x}_{i}} ) & ( Equation 3 )\end{matrix}$$

For example, in the case of the product shown above (ice creams), it is said that the learning unit 20 learns a function that represents correspondence between attributes of ice creams and predicted sales.

The attribute generation unit 30 generates attributes of the target based on the prediction model of the attribute viewpoint learned for each target. As described above, the prediction model is a model that shows how an evaluation result will change when the target person is fixed and the target is replaced, and represents an evaluation result for each target person when an attribute of the target is specified.

Selecting a combination of each attribute for a prediction model will determine an overall evaluation result. Therefore, the attribute generation unit 30 generates attributes under a defined constraint so that an evaluation result obtained according to the attribute applied to the learned prediction model satisfy the specified objective.

For example, suppose the prediction model is calculated using Equation 2 shown above, and the objective is to obtain the attribute that maximizes average sales. In this case, the average sales for the attribute vector a_{U} can be expressed by Equation 4 illustrated below, based on Equation 1.

$$\begin{matrix}[ Math . 4 ] & \\ \frac{1}{n} {\sum }_{i = 1}^{n} {a}_{U}^{⊤} {\hat{s}}_{{x}_{i}} & ( Equation 4 )\end{matrix}$$

In fact, a_{U} is an unknown attribute. Therefore, the attribute generation unit 30 generates an attribute that maximizes the average sales by solving the optimization problem of Equation 5 illustrated below. In Equation 5, S is an (m×n) dimensional matrix consisting of the coefficients of the prediction model for each target person.

$$\begin{matrix}[ Math . 5 ] & \\ {maximize}_{{a}_{U} ∈ {ℝ}^{m}} {a}_{U}^{⊤} \hat{S} {1}_{n} & ( Equation 5 ) \\ subject to {‖ {a}_{U} ‖}_{2}^{2} = 1 & \end{matrix}$$

By solving the optimization problem of Equation 5 shown above, the attribute a\hat{ }_{U} (circumflex on a_{U}) is calculated as shown in Equation 6 below.

$$\begin{matrix}[ Math . 6 ] & \\ {a}_{U} := = \frac{1}{\sqrt{{1}_{n}^{⊤} \hat{S} {\hat{S}}^{⊤} {1}_{n}}} {\hat{S}}^{⊤} {1}_{n} & ( Equation 6 )\end{matrix}$$

An attribute can be generated in the same way for general models. For example, suppose that the prediction model is calculated using Equation 3 shown above, and the objective is to obtain an attribute that maximizes the average sales in the same way. In this case, the average sales for the attribute vector a_{U} can be expressed by Equation 7 illustrated below.

$$\begin{matrix}[ Math . 7 ] & \\ \frac{1}{n} {\sum }_{i = 1}^{n} {\hat{f}}_{{x}_{i}} ( {a}_{U} ) & ( Equation 7 )\end{matrix}$$

At this time, the attribute generation unit 30 can generate an attribute that maximize average sales by solving the optimization problem of Equation 8 illustrated below. The attribute generation unit 30 may, for example, calculate the gradient with respect to a in the objective function and update a, and then solve the optimization problem of Equation 8 so that the updated and normalized a satisfies constraint (i.e., by the projective gradient method).

$$\begin{matrix}[ Math . 8 ] & \\ {maximize}_{{a}_{U} ∈ {ℝ}^{m}} {\sum }_{i = 1}^{n} {\hat{f}}_{{x}_{i}} ( {a}_{U} ) & ( Equation 8 ) \\ subject to {‖ {a}_{U} ‖}_{2}^{2} = 1 & \end{matrix}$$

In this way, the attribute generation unit 30 may generate an attribute in the defined constraint so that an evaluation result obtained according to the attribute applied to the learned prediction model maximizes the average sales.

The number of attributes that the attribute generation unit 30 generates is not limited to one, but may be multiple. The attribute generation unit 30, for example, may generate multiple attributes that make the sales as high as possible.

For example, suppose that the prediction model is calculated using Equation 2 shown above, and the objective is to obtain three attributes that result in higher sales. In this case, the attribute generation unit 30 may generate multiple (three) attributes by solving the optimization problem of Equation 9 illustrated below.

$$\begin{matrix}[ Math . 9 ] & \\ {maximize}_{τ , {\{ {a}_{U ℓ} ∈ {ℝ}^{m} \}}_{ℓ = 1}^{3}} τ & ( Equation 9 ) \\ subject to {a}_{U ℓ}^{⊤} \hat{S} {1}_{n} \geq τ ℓ = 1 , 2 , 3 & \end{matrix}$$

In addition, a constraint of Equation 10 illustrated below, may be added to ensure that each of generated multiple attributes represent various attributes.

$$\begin{matrix}[ Math . 10 ] & \\ {A}_{U} {A}_{U}^{⊤} = {I}_{3} & ( Equation 10 ) \\ {A}_{U} := {( {a}_{U 1} , {a}_{U 2} , {a}_{U 3} )}^{⊤} & \end{matrix}$$

The constraint illustrated in Equation 10 is a constraint condition to obtain various attributes and to prevent the selection of relational attributes from each other. Specifically, this constraint condition can be defined as a condition that an inner product of the matrix containing the attribute vector to be generated and the transpose matrix of that matrix is the identity matrix. As illustrated in Equation 10, by generating orthogonal attributes, diversification of the attributes to be generated can be achieved. In practical terms, the constraint that the generated vectors are orthogonal to each other can be changed to a constraint that the inner product of the vectors is less than or equal to an appropriate threshold. This makes it possible to obtain a solution in a short computation time while achieving an effect similar to that of the constraint that vectors are orthogonal to each other.

For example, in the case of the product described above (ice creams), the attribute generation unit 30 generates new ice cream attributes that maximize the learned function under the constraint of nutritional ingredients, raw materials, content volume and so on. The attribute generation unit 30 presents the ice creams with the generated attributes to the user as new ice creams with potential sales.

The attribute generation unit 30 may also generate the desired target person image by applying an attribute to the prediction model of the attribute viewpoint. Specifically, the attribute generation unit 30 may obtain evaluation results by applying an attribute to the prediction model of the attribute viewpoint, and generate the desired target person image by identifying target persons whose evaluation results satisfy specified conditions. In addition, if a range of target persons (hereinafter, sometimes referred to as a domain) to be identified is specified, the attribute generation unit 30 may identify the desired target person image from within the domain.

For example, assume the case of generating a target person image which is expected to generate sales of a new product that has been developed. If the prediction model is represented by a linear model as exemplified in Equation 1 above, and the attribute of the new developed product is a_{new}, the sales to each target person are predicted by Equation 11 as exemplified below.

[Math. 11]

{a_{new}^{T}ŝᵢ}ᵢ₌₁ⁿ (Equation 11)

Therefore, the attribute generation unit 30 identifies the target persons to whom sales calculated based on the above equation 11 satisfy the specified condition. For example, if the condition “select the target persons in the top 10% with the highest sales” is specified, the attribute generation unit 30 identifies the target persons to whom calculated sales are within the top 10%.

The attribute generation unit 30 may present the identified target persons to the user as they are. The attribute generation unit 30 may also generate and output an average image of the multiple identified target persons. The method of generating the average image includes the method of calculating the average of the evaluation results and the method of generating the average image of the target persons.

The attribute generation unit 30 may, for example, calculate the average of the sales of the top 10% of the target persons based on Equation 12 illustrated below. When the target person is identified by, for example, a user ID, in Equation 12, r(·) is defined as a function that returns the rank of the user IDs when they are arranged in order of increasing sales.

[Math. 12]

{xᵣ₍ᵢ₎}ᵢ₌₁^{└0.1n┘} (Equation 12)

The method by which the attribute generation unit 30 generates the average image of the target person is arbitrary. For example, the attribute generation unit 30 may calculate the average by considering the manifold structure of the target person data and output a result of the calculation as the average image of the target person. Specifically, preference of the target user for a particular element is often not linear. Therefore, the attribute generation unit 30 may calculate the average by taking into account non-linearity (or by learning non-linearity using other machine learning methods) of the changes in likes and dislikes.

In the above explanation, an example of a product (ice creams) as a target is explained. The same method can be used to generate an attribute for a store or a service as other targets. Hereinafter, specific examples of a store and a service will be explained.

In the example of a store (convenience store), the attribute variables of an existing store can be mentioned. Specifically, features (i.e., attribute variables) of ice creams include location information (Kanto region, Kanagawa Prefecture, Kawasaki City, Nakahara Ward, Shimonumabe, etc.), demographic information (population, population by age group, gender ratio, etc.), neighborhood information (vicinity of government offices, vicinity of schools, vicinity of companies, along main roads, etc.), estimated population within a radius of 1 km, the size of the store, and the number of parking spaces available. Other variables such as the status of the surrounding residents, nearby stores, site, number of floors, and type of business may also be used as attribute variables.

In addition, a set of predictors is prepared to predict sales for each store. These predictors may be operational or newly generated. The predictors use, for example, date information and weather information as input to predict sales. Then the input data (for example, date information or weather information during a suitable period of time) to be targeted for predicting is prepared, and the predicted sales of existing stores are calculated using the above predictors and used as learning data.

The learning unit 20 learns a prediction model of the store attribute viewpoint based on the learning data. Specifically, the learning unit 20 learns a function that represents the correspondence between the attributes of each store and the predicted sales. The attribute generation unit 30 generates an attribute of a new store that maximizes the learned function under constraint such as store area. The attribute generation unit 30 may, for example, select a store attribute that maximize the learned function from attributes of new store candidates. The attribute generation unit 30 then presents the attribute of the new store that are expected to generate sales.

In an example of a service (meal service), the attribute variables of an existing meal service can be mentioned. Specifically, these include calories, nutritional ingredients, quantity, and amount. Other elements such as the monthly cost, elements that make up the service (for example, cable TV channels, various supplements in the regular supplement delivery, various clothes (rental) in the regular clothes delivery, various confectionery in the regular confectionery delivery, various foods in the regular food delivery, various cosmetics in the regular cosmetics delivery, various cosmetics in the regular comic books, etc.) may be used as attribute variables.

In addition, a set of predictors is prepared to predict satisfaction of each service. These predictors may also be operational or newly generated. The predictors can be, for example, used customer attributes and purchase history as inputs to predict the satisfaction with the delivered meal. Here, it is assumed that in the meal service, there are various sets (for example, full set, low-salt set, no-pressure diet set, etc.). Then, input data (for example, a specific customer or multiple customers) to be targeted is prepared, and the predicted sales of existing stores are calculated using the above predictors and used as learning data.

The learning unit 20 learns a prediction model of the service attribute viewpoint based on the learning data. Specifically, the learning unit 20 learns a function that represents correspondence between the attribute of each service and the predicted satisfaction. The attribute generation unit 30 generates new service attribute that maximize the learned function under constraint such as calories, quantity, nutritional ingredients, and amount. The attribute generation unit 30 then presents the attribute of the new service that are expected to be satisfactory.

The learning unit 20 and the attribute generation unit 30 are realized by a computer processor (e.g., CPU (Central Processing Unit), GPU (Graphical Processing Unit), FPGA (field-programmable gate array)) operating according to a program (attribute generation program).

For example, the program may be stored in the storage unit 10 provided by the attribute generation device, and the processor may read the program and operate according to the program as the learning unit 20 and attribute generation unit 30. The functions of the attribute generation device may also be provided in SaaS (Software as a Service) format.

The learning unit 20 and the attribute generation unit 30 may each be implemented in dedicated hardware. Some or all of the components of each device may be realized by general-purpose or dedicated circuit (circuitry), processors, or combinations thereof. These may be configured by a single chip or by multiple chips connected through a bus. Some or all of the components of each device may be realized by a combination of the above-mentioned circuits and programs.

In the case where some or all of the components of the attribute generation device are realized by a plurality of information processing devices, circuits, or the like, the plurality of information processing devices, circuits, or the like may be centrally located or distributed. For example, the information processing devices, circuits, etc. may be realized as a client-server system, a cloud computing system, etc., each of which is connected through a communication network.

Next, the operation of the attribute generation device of this example embodiment will be described. FIG. 2 is a flowchart showing an example of a setting process when generating attributes.

First, an attribute of each target is generated (step S11), and a predictor for each target is prepared (step S12). This predictor may be assumed to exist in advance or it may be newly generated. Next, the domain of feature to be targeted is set (step S13). This corresponds to setting the target persons as candidates. Then, the property (index) of the attribute to be generated is determined (step S14). Examples of an index include, for example, maximum average value, multiple candidates above a threshold value, and the like. Then, the attribute generation device 100 generates and outputs the attribute (step S15).

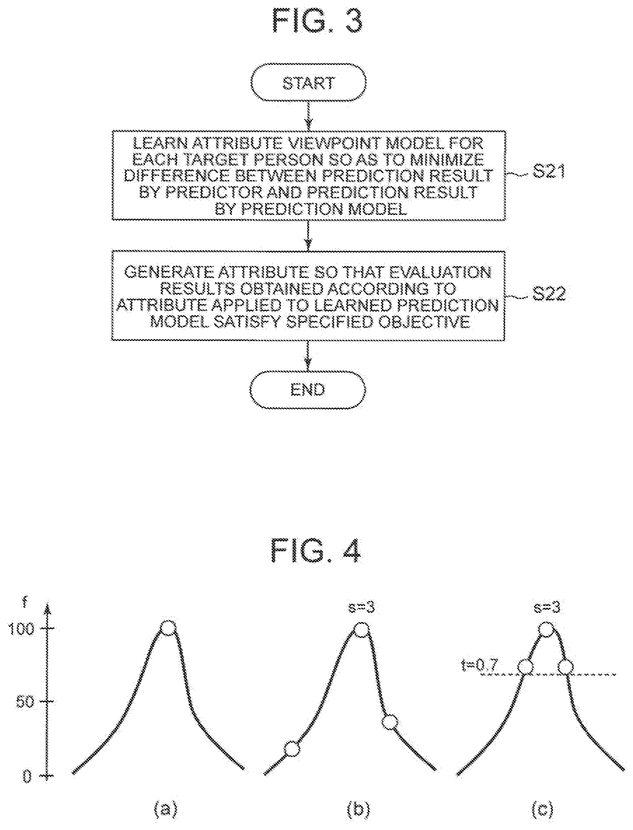

FIG. 3 is a flowchart showing an operation example of the attribute generation device 100. The learning unit 20 learns an attribute viewpoint model for each target person so as to minimize a difference between the prediction result by the predictor and the prediction result by the prediction model (step S21). Then, the attribute generation unit 30 generates an attribute so that the evaluation results obtained according to the attribute applied to the learned prediction model satisfy the specified objective (step S22).

As described above, in this example embodiment, the learning unit 20 learns attribute viewpoint model for each target so as to minimize the difference between the prediction result by the predictor that predicts the evaluation result for each target and the prediction result by the prediction model that predicts the evaluation result learned for each target using the target attributes as explanatory variables. Then, the attribute generation unit 30 generates an attribute so that the evaluation result obtained according to the attribute applied to the learned prediction model satisfy the specified objective. Thus, it is possible to generate an attribute that represents the target according to the objective.

In other words, by using the attribute generation device 100 of this example embodiment, it is possible to assist in the development of a new product, assist in the location and details of new store opening, and assist in the planning of a new service. Furthermore, by using the attribute generation device 100 of this example embodiment, it is also possible to analyze the target users of a new product or a new service, and to select users who are likely to pay a high price for a new product or a new service. Thus, it can be said that the attribute generation device 100 of this example embodiment promotes creative activities by generating an attribute of the viewpoint of high profitability and diversity in order to assist decision making in creative business activities.

For example, the non-patent literature 1 discloses a method which uses a category value as an attribute, but does not disclose a method which uses continuous values. In this example embodiment, an attribute can be generated in the same way even when the attribute value is a continuous value. When dealing with a category value in this example embodiment, the attribute generation device may binarize the category value and solve an optimization problem in which binary constraint is relaxed to bounded continuous value constraint. In that case, it is preferable to modify the constraint such as L2 norm of the attribute vector represented by real values being a unit (for example, limit a number of category variables that can be 0 or 1 in one attribute vector) as appropriate. Similarly, when generating various attribute vectors, the constraint is modified by restricting a number of attribute vectors that can output a specific category variable.

Next, a modification of this example embodiment will be described. In the above example embodiment, the case of generating attributes of a product with high average sales as the specified objective has been illustrated. Other specific examples of specified objective are described below. In the following explanation, it is assumed that there are k m-dimensional attribute vectors in which attribute variables of the target are aligned, and n d-dimensional vectors (d-dimensional feature vectors) in which feature of the target is aligned. Further, suppose that there are k functions (predictors) that output prediction values using the feature vectors as input. In this modification, real-value attribute vectors are considered to simplify the explanation. However, when dealing with attribute vectors which have attribute variables of category values or attribute variables of both real-values and category values, appropriate constraint can be added to the above real-values and category values depending on the type of attribute variable.

For each predictor, it is assumed that n prediction results for n pieces of feature explanatory variables) are obtained, and that the learning unit 20 has learned correspondence between the attribute variables corresponding to the predictor and the evaluation results as a prediction model. The set of target persons is denoted as X_{q}.

As a first objective, the case of obtaining an attribute (vector) that maximizes the evaluation results of the prediction model is given. The attribute generation unit 30 may calculate the attribute that satisfies this objective using Equation 13 illustrated below.

$$\begin{matrix}[ Math . 13 ] & \\ {max .}_{{a}_{U} ∈ {ℝ}^{m}} \frac{1}{\vert {χ}_{q} \vert} {\sum }_{{x}_{i} ∈ {χ}_{q}} {\hat{f}}_{{x}_{i}} ( {a}_{U} ) & ( Equation 13 ) \\ s . t . {a}_{U}^{⊤} {a}_{U} = 1 & \end{matrix}$$

As a second objective, the case of obtaining s various attribute variables that maximize the sum of the prediction models corresponding to the s attribute variables is given. The attribute generation unit 30 may calculate the attribute variables that satisfy this objective using Equation 14 illustrated below.

$$\begin{matrix}[ Math . 14 ] & \\ {max .}_{{\{ {a}_{U}^{( k )} \}}_{k = 1}^{s}} \frac{1}{\vert {χ}_{q} \vert} {\sum }_{{x}_{i} ∈ {χ}_{q}} {\hat{f}}_{{x}_{i}} ( {a}_{U}^{( k )} ) & ( Equation 14 ) \\ s . t . {A}_{U} {A}_{U}^{⊤} = {I}_{s} & \end{matrix}$$

As a third objective, the case of obtaining s various attribute variables that are greater than τ times the maximum value of the evaluation results of the prediction model is given. The attribute generation unit 30 may calculate the attribute variables that satisfy this objective using Equation 15 or Equation 16 illustrated below. The constraint in Equation 15 and Equation 16 are the same in both cases. In addition, τ≥0 is a hyperparameter.

$$\begin{matrix}[ Math . 15 ] & \\ {max .}_{{\{ {a}_{U}^{( k )} \}}_{k = 1}^{s}} & ( Equation 15 ) \\ {max .}_{{\{ {a}_{U}^{( k )} \}}_{k = 1}^{s} , τ \geq 0} τ & ( Equation 16 ) \\ s . t . \frac{1}{\vert {χ}_{q} \vert} {\sum }_{{x}_{i} ∈ {χ}_{q}} {\hat{f}}_{{x}_{i}} ( {a}_{U}^{( k )} ) \geq τ {f}_{max} , k = 1 , … , s \\ {A}_{U} {A}_{U}^{⊤} = {I}_{s} & \\ where & \\ {f}_{max} := {max .}_{i , t} {\hat{f}}_{x , i} ( {a}^{( t )} ) & \end{matrix}$$

FIG. 4 is an explanatory diagram showing a specific example of a process of generating attributes. The graph illustrated in FIG. 4(a) corresponds to the first objective and shows that the attribute indicated by the circle is selected such that the evaluation result is maximized. The graph illustrated in FIG. 4(b) corresponds to the second objective and shows that respective three (s=3) attributes are generated from the evaluation results, from various viewpoints. The graph illustrated in FIG. 4(c) corresponds to the third objective and shows that respective three (s=3) attributes are generated from the evaluation results that are greater than 0.7 times (t=0.7) the maximum value, from various viewpoints.

As a fourth objective, the case of obtaining attribute variables that reduce the variance of the evaluation results of the prediction model is given. By making the variance of the evaluation results smaller, the utility for the obtained attribute variables can be prevented from fluctuating greatly. In this case, the attribute generation unit 30 can use an average of the evaluation results for m known attribute variables as the average in the variance calculation. Specifically, the attribute generation unit 30 may calculate the attribute variables that satisfy this objective using Equation 17 illustrated below.

$$\begin{matrix}[ Math . 16 ] & \\ {min .}_{{a}_{U}} \frac{1}{\vert {χ}_{q} \vert} {\sum }_{{x}_{i} ∈ {χ}_{q}} {( {\hat{f}}_{{x}_{i}} ( {a}_{U} ) - \frac{1}{\vert {χ}_{q} \vert} {\sum }_{{x}_{i} ∈ {χ}_{q}} {\hat{f}}_{{x}_{i}} ( {a}_{U} ) )}^{2} & ( Equation 17 )\end{matrix}$$

As a fifth objective, the case of obtaining an attribute variable that maximizes the CVaR (Conditional Value at Risk) calculated based on the evaluation results of the prediction model for the n explanatory variables is given. The attribute generation unit 30 may calculate the attribute variable that satisfies this objective using Equation 18 illustrated below. The α (0≤α≤1) of CVaR illustrated in Equation 18 indicates a percentage from the smaller evaluation result. For example, when considering up to 5% of the percentage from the smaller of the evaluation results, α=0.05 is set.

$$\begin{matrix} [ Math . 17 ] & \\ {max .}_{{a}_{U}} {CVaR}_{α} ( {\{ {\hat{f}}_{{x}_{i}} \}}_{i = 1}^{\vert {χ}_{q} \vert} , {a}_{U} ) & ( Equation 18 ) \\ s . t . {a}_{U}^{⊤} {a}_{U} = 1 & \\ {CVaR}_{α} ( {\{ {f}_{{x}_{i}} \}}_{i = 1}^{n} , a ) := {max .}_{τ ∈ ℝ} ( τ - \frac{1}{α n} {\sum }_{i = 1}^{n} max ( 0 , τ - {f}_{{x}_{i}} ( a ) ) ) & \end{matrix}$$

As a sixth objective, the case, where n explanatory variables are clustered and the attribute variable that maximizes the evaluation result for each cluster is obtained, is given. In this case, the attribute generation unit 30 first performs clustering based on feature using a clustering method such as k-means to generate the cluster {Cⱼ}^{K}ⱼ₌₁ of target persons. Then, the attribute generation unit 30 can perform the process shown in the first objective above for each cluster.

As a seventh objective, the case of obtaining the attribute vector that maximizes the evaluation results, under constraint of cost (for example, budget) for that attribute, is given. In other words, this is a case where an attribute is chosen so that the cost when each attribute variable is selected becomes to be less than or equal to the budget when the budget is indicated, is given. The cost may be based on the value of the attribute variable (for example, a cost that increases as the value increases). In this case, the attribute generation unit 30 may calculate the attribute (vector) using Equation 19 illustrated below under the budget constraint.

$$\begin{matrix}[ Math . 18 ] & \\ {max .}_{{a}_{U} ∈ {ℝ}^{m}} \frac{1}{\vert {χ}_{q} \vert} {\sum }_{{x}_{i} ∈ {χ}_{q}} {\hat{f}}_{{x}_{i}} ( {a}_{U} ) & ( Equation 19 ) \\ s . t . {a}_{U}^{⊤} {a}_{U} = 1 & \\ {a}_{U}^{⊤} c \leq P & \end{matrix}$$

In Equation 19, P is the maximum value of the cost, and c is the cost vector indicating the cost. For example, when there are four attribute variables, the cost vector c is defined corresponding to the attribute variables, such as c=(10, 5, 3, 7)^{T}, where the unit is ten thousand yen.

When Equation 19 shown above is used, an attribute vector that uses the maximum cost may be calculated. On the other hand, even if the maximum cost is set, it is preferable to suppress the cost as much as possible. Therefore, the attribute generation unit 30 may calculate attributes (vectors) using Equation 20 illustrated below so as to suppress the cost. In Equation 20, τ≥0 is a hyperparameter.

$$\begin{matrix}[ Math . 19 ] & \\ {max .}_{{a}_{U} ∈ {ℝ}^{m} , ξ \geq 0} \frac{1}{\vert {χ}_{q} \vert} {\sum }_{{x}_{i} ∈ {χ}_{q}} {\hat{f}}_{{x}_{i}} ( {a}_{U} ) + τ ξ & ( Equation 20 ) \\ s . t . {a}_{U}^{⊤} {a}_{U} = 1 & \\ {a}_{U}^{⊤} c \leq P - ξ & \end{matrix}$$

As an eighth objective, the case of obtaining s attribute vectors from the top that maximizes the evaluation results of the prediction model is given. The attribute generation unit 30 may calculate the attributes (vectors) that satisfy this objective using Equation 21 illustrated below.

$$\begin{matrix}[ Math . 20 ] & \\ {max .}_{{\{ {a}_{U}^{( j )} \}}_{j = 1}^{s}} {\sum }_{j = 1}^{s} {\sum }_{{x}_{i} ∈ {χ}_{q}} {f}_{{x}_{i}} ( {a}_{U}^{( j )} ) & ( Equation 21 ) \\ s . t . {A}_{U} {A}_{U}^{⊤} = {I}_{s} & \end{matrix}$$

As a ninth objective, the case of obtaining the three attribute vectors from which a mean value of the evaluation results, the maximum value of the evaluation results, and an intermediate value between the mean value and the maximum value are obtained, is given. When a user is presented with a new attribute that is predicted to have the maximum value, the user may not feel fully satisfied because there is no target for comparison. Assuming such a case, the attribute generation unit 30 generates attributes from which respective ranked evaluation results, i.e., the attributes that are expected to obtain the maximum value, the intermediate value, and the average value (in other words, ranked regular, special, premium, etc.) are obtained, and presents them to the user. The presentation makes it possible to increase feeling of satisfaction of the user.

First of all, the attribute generation unit 30 calculates the attribute that would maximize the evaluation results using, for example, Equation 22 illustrated below, similar to the process shown in the first objective. Next, the attribute generation unit 30 calculates the attribute (vector) from which the average of the evaluation results is obtained, using Equation 23 illustrated below. Then, the attribute generation unit 30 calculates the attribute (vector) from which the intermediate value of the evaluation result is obtained, using Equation 24 illustrated below.

$$\begin{matrix}[ Math . 21 ] & \\ {f}_{AAA} := \frac{1}{\vert {χ}_{q} \vert} {\sum }_{{x}_{i} ∈ {χ}_{q}} {\hat{f}}_{{x}_{i}} ( \hat{a} ) & ( Equation 22 ) \\ {f}_{A} := \frac{1}{k \vert {χ}_{q} \vert} {\sum }_{t = 1}^{k} {\sum }_{{x}_{i} ∈ {χ}_{q}} {f}_{{x}_{i}} ( {a}^{( t )} ) & ( Equation 23 ) \\ {f}_{AA} := \frac{1}{2} ( {f}_{AAA} + {f}_{A} ) & ( Equation 24 ) \\ \begin{matrix}{min .}_{{a}_{AA} ∈ {ℝ}^{m} , τ \geq 0} τ \\ s . t . {f}_{AA} - τ \leq \frac{1}{\vert {χ}_{q} \vert} {\sum }_{{x}_{i} ∈ {χ}_{q}} {f}_{{x}_{i}} ( {a}_{AA} ) \\ \frac{1}{\vert {χ}_{q} \vert} {\sum }_{{x}_{i} ∈ {χ}_{q}} {f}_{{x}_{i}} ( {a}_{AA} ) \leq {f}_{AA} + τ \\ {a}_{AA}^{⊤} {a}_{AA} = 1\end{matrix} & \\ \begin{matrix}{min .}_{{a}_{A} ∈ {ℝ}^{m} , τ \geq 0} τ \\ s . t . {f}_{A} - τ \leq \frac{1}{\vert {χ}_{q} \vert} {\sum }_{{x}_{i} ∈ {χ}_{q}} {f}_{{x}_{i}} ( {a}_{A} ) \\ \frac{1}{\vert {χ}_{q} \vert} {\sum }_{{x}_{i} ∈ {χ}_{q}} {f}_{{x}_{i}} ( {a}_{AA} ) \leq {f}_{A} + τ \\ {a}_{A}^{⊤} {a}_{A} = 1\end{matrix} & \end{matrix}$$

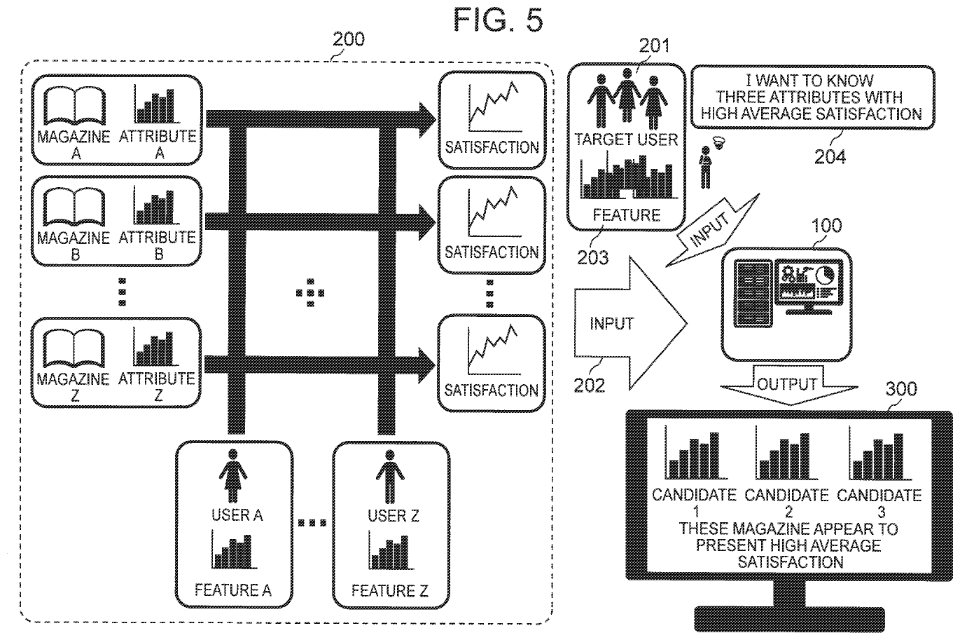

Next, a specific example of the operation of the attribute generation device will be explained. FIG. 5 is an explanatory diagram explaining an operation example of generating attributes. The example shown in FIG. 5 is an example of a system that generates attributes for a new magazine in a situation where there is a system 200 that can predict the degree of user satisfaction with each magazine.

Assuming a situation where, as an objective, it is desired to know three attributes with the high average satisfaction of a target user 201 indicated by certain feature. In this case, an evaluation result 202 output from the system 200 and feature 203 of the target user 201 are input to an attribute generation device 100 along with a query 204 indicating the objective. Here, the evaluation result 202 corresponds to the evaluation result by the attribute viewpoint model, and the feature 203 corresponds to the feature vector of the target user to be targeted. In addition, the query 204 indicating the objective corresponds to the objective specified when generating the attribute.

The attribute generation device 100 presents an attribute of the new magazine to the user by outputting the generated attribute to the output device 300.

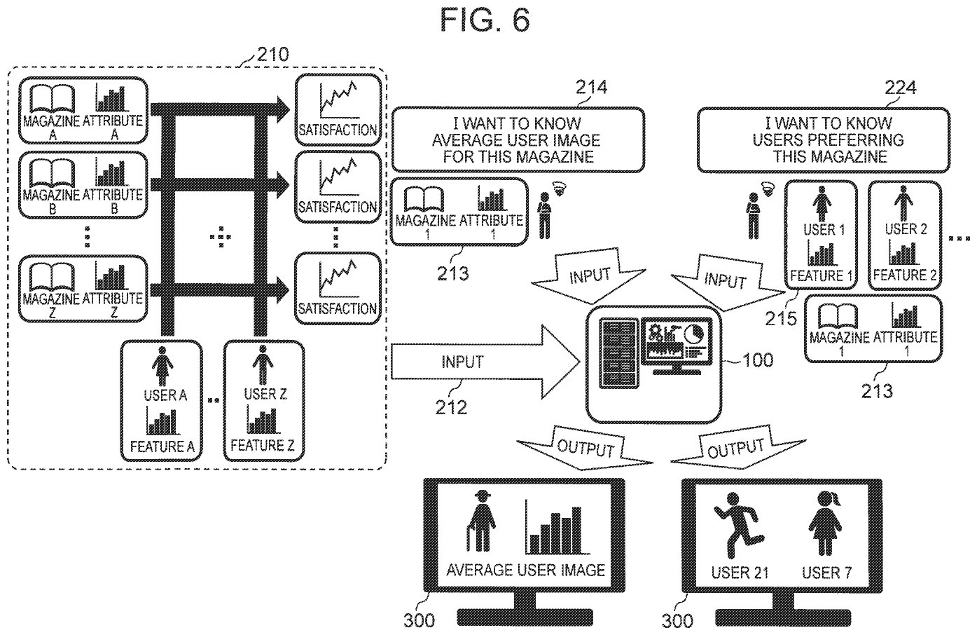

FIG. 6 is an explanatory diagram explaining an operation example of generating a target person image and selecting a target person. The example shown in FIG. 6 is an example of a system that generates an average user image that prefers a certain magazine and identifies users who prefer a certain magazine among a group of users, in a situation where there is a system 210 that can predict the user satisfaction.

First, suppose that it is desired to know the average user image that prefers magazine 1 represented by attribute 1. In this case, the evaluation result 212 output from the system 210 and the attribute 213 of the magazine are input to the attribute generation device 100 along with the query 214 indicating the objective. Here, the evaluation result 212 corresponds to the evaluation result by the attribute viewpoint model, and the attribute 213 corresponds to the attribute vector of the target. The query 214 indicating the objective corresponds to the query representing the desired target person image. The attribute generation device 100 identifies a user (target person) based on the query and generates an average user image.

Next, suppose that it is desired to identify users who prefer magazine 1 represented by attribute 1, from the range of the specified target persons. In this case, the evaluation results 212 output from the system 210, the attributes 223 of the magazine and the feature 215 of the user are input to the attribute generation device 100, together with a query 224 indicating the objective. Here, the user 215 corresponds to the target person within the specified range. The attribute generation device 100 identifies the user (target person) based on the query.

The attribute generation device 100 presents the users to be targeted to the users by outputting the average user image and the identified users to the output device 300.

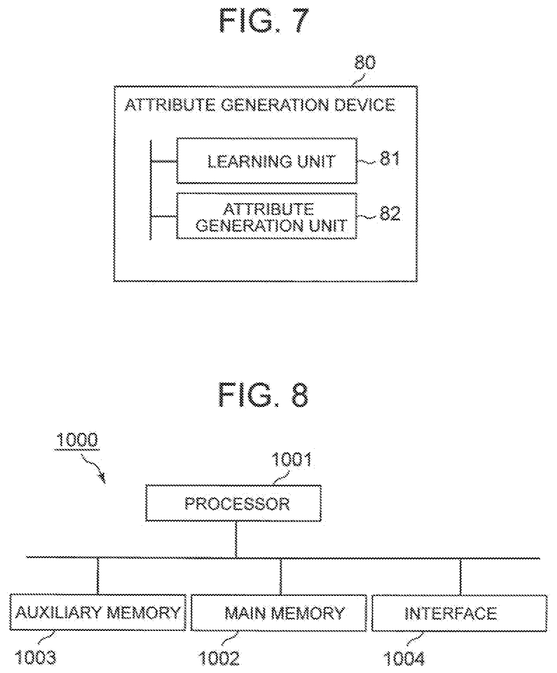

Next, an overview of the present invention will be explained. FIG. 7 is a block diagram showing a summarized attribute generation device according to the present invention. An attribute generation device 80 (for example, attribute generation device 100) according to the present invention includes a learning unit 81 (for example, learning unit 20) which learns an attribute viewpoint model in which attributes of a target are explanatory variables for each target person (for example, individual user, group, company, etc.) so as to minimize a difference between a prediction result by a predictor that predicts an evaluation result (for example, rating, sales, satisfaction, etc.) of each target person for each target (for example, product, service, store, etc.) based on a feature vector of the target person and a prediction result by a prediction model that predicts an evaluation result learned for each target person, using the attributes of the target as explanatory variables, and an attribute generation unit 82 (for example, attribute generation unit 30) which generates an attribute so that an evaluation result obtained according to the attribute applied to the learned prediction model satisfies a specified objective (for example, to generate an attribute that maximizes average sales, etc.).

By such a configuration, an attribute that represents the target according to the objective is generated.

The attribute generation unit may generate multiple attributes to satisfy the specified objective under a constraint condition (for example, an orthogonal matrix of attribute vectors becomes to be an identity matrix, etc.) in which selecting relational attributes is prevented. By such a configuration, it becomes to be possible to generate various attributes.

The attribute generation unit may generate a desired target person image (for example, a user image that prefers the attribute of the target) by applying the attribute to the attribute viewpoint model.

The attribute generation unit may identify a desired target person among the target persons within a specified range by applying the attribute to the attribute viewpoint model.

The attribute generation unit may generate the attributes from which respective ranked (for example, in order of maximum value, intermediate value, average value, etc.) prediction results are obtained. By such a configuration, it becomes to be possible to increase the feeling of satisfaction of the user.

FIG. 8 is a summarized block diagram showing a configuration of a computer for at least one example embodiment. The computer 1000 comprises a processor 1001, a main memory 1002, an auxiliary memory 1003, and an interface 1004.

The attribute generation device described above is implemented in the computer 1000. The operation of each of the above mentioned processing units is stored in the auxiliary memory 1003 in a form of a program (attribute generation program). The processor 1001 reads the program from the auxiliary memory 1003, deploys the program to the main memory 1002, and implements the above described processing in accordance with the program.

In at least one exemplary embodiment, the auxiliary memory 1003 is an example of a non-transitory tangible medium. Other examples of non-transitory tangible media include a magnetic disk, an optical magnetic disk, a CD-ROM (Compact Disc Read only memory), a DVD-ROM (Read-only memory), a semiconductor memory, and the like. When the program is transmitted to the computer 1000 through a communication line, the computer 1000 receiving the transmission may deploy the program to the main memory 1002 and perform the above process.

The program may also be one for realizing some of the aforementioned functions. Furthermore, the program may be a so-called differential file (differential program), which realizes the aforementioned functions in combination with other programs already stored in the auxiliary memory 1003.

### REFERENCE SIGNS LIST

10 Storage unit
20 Learning unit
30 Attribute generation unit
100 Attribute generation device

What is claimed is:

1. An attribute generation device comprising a hardware processor configured to execute a software code to:
learn an attribute viewpoint model in which attributes of a target are explanatory variables for each target person so as to minimize a difference between a prediction result by a predictor that predicts an evaluation result of each target person for each target based on a feature vector of the target person and a prediction result by a prediction model that predicts an evaluation result learned for each target person, using the attributes of the target as explanatory variables; and
generate an attribute so that an evaluation result obtained according to the attribute applied to the learned prediction model satisfies a specified objective.

2. The attribute generation device according to claim 1, wherein the hardware processor is configured to execute a software code to
generate multiple attributes to satisfy the specified objective under a constraint condition in which selecting relational attributes is prevented.

3. The attribute generation device according to claim 1, wherein the hardware processor is configured to execute a software code to
generate a desired target person image by applying the attribute to the attribute viewpoint model.

4. The attribute generation device according to claim 1, wherein the hardware processor is configured to execute a software code to
identify a desired target person among the target persons within a specified range by applying the attribute to the attribute viewpoint model.

5. The attribute generation device according to claim 1, wherein the hardware processor is configured to execute a software code to
generate the attributes from which respective ranked prediction results are obtained.

6. An attribute generation method comprising:
learning an attribute viewpoint model in which attributes of a target are explanatory variables for each target person so as to minimize a difference between a prediction result by a predictor that predicts an evaluation result of each target person for each target based on a feature vector of the target person and a prediction result by a prediction model that predicts an evaluation result learned for each target person, using the attributes of the target as explanatory variables; and
generating an attribute so that an evaluation result obtained according to the attribute applied to the learned prediction model satisfies a specified objective.

7. The attribute generation method according to claim 6, wherein
multiple attributes to satisfy the specified objective are generated under a constraint condition in which selecting relational attributes is prevented.

8. A non-transitory computer readable information recording medium storing an attribute generation program, when executed by a processor, that performs a method for:
learning an attribute viewpoint model in which attributes of a target are explanatory variables for each target person so as to minimize a difference between a prediction result by a predictor that predicts an evaluation result of each target person for each target based on a feature vector of the target person and a prediction result by a prediction model that predicts an evaluation result learned for each target person, using the attributes of the target as explanatory variables; and
generating an attribute so that an evaluation result obtained according to the attribute applied to the learned prediction model satisfies a specified objective.

9. The non-transitory computer readable information recording medium according to claim 8, wherein
multiple attributes to satisfy the specified objective are generated under a constraint condition in which selecting relational attributes is prevented.
